(19) United States
(12) Patent Application Publication
(10) Pub. No.: US 2004/0209010 A1
(43) Pub. Date: Oct. 21, 2004

(54) Aqueous coating formulation suitable for use with high speed coaters such as rod and blade coaters, and ink jet recording materials prepared therefrom

(76) Inventor: Simon R. Cuch, East Longmeadow, MA (US)

Correspondence Address: Mary R. Bonzagni, Esq., Holland & Bonzagni, P.C., Suite 302, 171 Dwight Road, Longmeadow, MA, 01106-1700, US

(21) Appl. No.: 10/718,384

(22) Filed: Nov. 19, 2003

Related U.S. Application Data
(63) Continuation-in-part of application No. 10/267,290, filed on Oct. 8, 2002.
(60) Provisional application No. 60/328,180, filed on Oct. 9, 2001.

(51) Int. Cl. B41M 5/00

(52) U.S. Cl. 428/32.24

(57) ABSTRACT

An aqueous coating formulation for use in preparing ink jet recording materials is provided. The coating formulation, which employs a major amount of porous pigments and/or metal oxide gels in combination with a minor amount of select inorganic pigments (i.e., calcium carbonate and mixtures of calcium carbonate and alumina), is suitable for use with high speed coaters such as rod and blade coaters. An ink jet recording material prepared using such an aqueous coating formulation is also provided. The ink jet recording material demonstrates good printability and provides images having excellent water and humidity resistance and high image densities. In a preferred embodiment, the inventive recording material further demonstrates good light or fade resistance.

### RELATED APPLICATION

This application is a continuation-in-part of U.S. patent application Ser. No. 10/267,290, filed Oct. 8, 2002, which claims priority from U.S. Provisional Patent Application Serial No. 60/328,180, filed Oct. 9, 2001.

### FIELD OF THE INVENTION

The present invention generally relates to an aqueous coating formulation for use in preparing ink jet recording materials. The aqueous coating formulation employs a major amount of porous pigments and/or metal oxide gels in combination with a minor amount of select inorganic pigments in its pigment composition yet is suitable for use with high speed coaters such as rod and blade coaters. Ink jet recording materials prepared using such an aqueous coating formulation are suitable for use in wide format printing applications, demonstrate good printability and can provide images having excellent water and humidity resistance and high image densities. In a preferred embodiment, the inventive recording material further demonstrates good light or fade resistance.

### BACKGROUND OF THE INVENTION

Wide format ink jet recording materials are typically manufactured as wide rolls (i.e., greater than or equal to 24 inches in width), and are roll-fed into large printers for imaging. These materials are commonly used in commercial settings for applications including large advertisements, movie theater posters, outdoor signage and the like.

Unlike narrow format ink jet recording materials, wide format materials, which are intended for long distance viewing, are required to meet more rigorous performance standards. For example, long distance viewing demands heightened acuity or sharpness in formed images and increased color gamut, background brightness and whiteness. In addition, wide format ink jet materials are often exposed to different use environments (e.g., outdoor use), which place additional demands on these materials in terms of color stability, resistance to light-induced fading, waterfastness, humidity resistance, abrasion resistance, and the like. It is further noted that wide format ink jet recording materials may encounter more ink per unit area when run through certain commercial printers and thus must effectively address problems with poor image quality, color bleed, smearing and cockle.

Prior art attempts to meet these more rigorous performance requirements include the use of fluorescent whitening agents in ink jet coatings to increase the background brightness and whiteness of resulting recording materials. Fluorescent whitening agents, however, degrade and, to a lesser extent, react with other coating components thereby contributing to the yellowing (i.e., poor light or fade resistance) of the resulting ink jet recording material.

Efforts to minimize this effect include decreasing the level of fluorescent whitening agents in the ink jet coating. Unfortunately, the corresponding decrease in background brightness/whiteness renders such materials less suitable for use in wide format printing applications. Attempts to correct this deficiency by using superior or more expensive grades of exceptionally white and bright base paper, adversely impacts upon the economics of these materials.

U.S. Pat. No. 6,129,785 to Schliesman et al. discloses a low pH aqueous suspension for application to optionally sized substrates, such as paper. The aqueous suspension comprises: absorptive silica pigment (e.g., a mixture of ≧75% silica gel having a pore volume of 0.5 to 1.5 cc/g and ≧10% alumina or alumina hydrate), a polyvinyl alcohol binder (e.g., low molecular weight, partially hydrolyzed polyvinyl alcohols) and a cationic fixing agent (e.g., polydiallyl dimethyl ammonium chloride), dispersed at low pH ranges of 4.0 to 7.5 (preferably 4.5 to 5.5). Alumina is added as a whitening agent and to improve rheology. The acidic pH of the aqueous suspension is believed to enhance cationic function resulting in rapid dry times and improved ink hold out and color density.

Recording materials prepared from low pH coating compositions, however, are less suitable for use in wide format printing applications where these materials tend to be less stable and thus more susceptible to fading and yellowing. Moreover, images formed on the recording materials described in Schliesman et al. have image densities that are too low to render these materials suitable for use in wide format printing applications.

PCT/GB00/04740 (WO 01/45956 A1) relates to a pigment coating for ink jet printing paper that comprises: a major proportion of a finely divided precipitated calcium carbonate (PCC) having a surface area of at least about 60 m²/g (preferably 80 to 90 m²/g); a minor proportion of a gel-type silica (i.e., 15 to 30% by wt., based on the total weight of silica and PCC); and a binder. The pigment coating, which is preferably made up as an aqueous composition having a solids content of 25 to 35% and a Brookfield viscosity of 150 to 2000 mPa s, may be applied to paper using a blade coating technique. According to this reference, pigment coatings based primarily on silica pigments are difficult (if not impossible) to apply using blade coating techniques “partly for rheological reasons and partly for print quality reasons.” Page 2, lines 12 to 17, of PCT/GB00/04740. Binder/pigment ratios ranging from 1:7.9 to 1:21 are used to prepare the pigment coatings for the working examples described in this reference.

While ink jet printing papers prepared from such pigment coatings may be applied by a blade coating technique, print quality is sacrificed due to the reduction of silica pigments in the pigment coating, rendering these materials also unsuitable for use in wide format printing applications.

In view of the above, a need exists for ink jet recording materials, which are not susceptible to fading or yellowing, and which produce high quality images.

It is, therefore, an object of the present invention to provide such an ink jet recording material.

It is a more particular object to provide an aqueous coating formulation, which may be applied to a substrate (e.g., paper) using high-speed coaters such as rod and blade coaters, and which can produce an ink jet recording material suitable for use in wide format printing applications.

It is another more particular object to provide an ink jet recording material suitable for use in wide format printing applications, which demonstrates good printability and which can provide images having excellent water and humidity resistance and high image densities.

It is yet another more particular object of the present invention to provide an economical, bright, white ink jet recording material, which demonstrates good printability and good light or fade resistance, and which provides images having excellent water and humidity resistance and high image densities.

### SUMMARY OF THE INVENTION

The present invention therefore provides an aqueous coating formulation suitable for use with high-speed coaters such as rod and blade coaters, which comprises:

a pigment composition comprising greater than or equal to 50% by dry wt., based on the total dry weight of the pigment composition, of a first pigment selected from the group of porous organic pigments, porous inorganic pigments, metal oxide gels and mixtures thereof, and less than 50% by dry wt., based on the total dry weight of the pigment composition, of a second pigment selected from the group of calcium carbonate and mixtures of calcium carbonate and alumina; and

a binder,

wherein, the binder/pigment dry weight ratio in the coating formulation ranges from about 1:8 to about 1:1.

The present invention further provides an ink jet recording material, which comprises a substrate and one or more ink jet receptive layers located on the substrate, which is/are prepared using the aqueous coating formulation described above.

The foregoing and other features and advantages of the present invention will become more apparent from the following detailed description and accompanying rheograms.

Unless otherwise defined, all technical and scientific terms used herein have the same meaning as commonly understood by one of ordinary skill in the art to which this invention belongs. All publications, patent applications, patents and other references mentioned herein, including but not limited to, U.S. Provisional Patent Application Serial No. 60/328,180 and U.S. patent application Ser. No. 10,267,290, are incorporated by reference in their entirety. In case of conflict, the present specification, including definitions, will control. In addition, the materials, methods, and examples are illustrative only and not intended to be limiting.

### BRIEF DESCRIPTION OF THE DRAWINGS

FIGS. 1 to 7 are rheograms plotting torque as a function of revolutions per minute (rpm), for inventive coating formulations I to VII, which are described in Tables 1A and 1B hereinbelow.

### DETAILED DESCRIPTION OF THE INVENTION

Although the present inventive ink jet recording material will be described herein mainly in reference to wide format printing applications, it is not so limited. The inventive material can be used in any application, including narrow format printing applications, where good printability and sharp, water and humidity resistant images, are desired.

As noted above, it has been recognized that pigment compositions containing a major amount of silica render the resulting coating formulation difficult (if not impossible) to use with high speed coaters such as rod and blade coaters, which require high shear apparent viscosities of generally greater than 10 but less than 50 centipoise (cps) (torque range: 1000 to 5500 kilodyne-cm, bob F2.5 at 8800 rpm). By way of the present invention, it has been discovered that such coating formulations even when prepared at relatively high solids contents (15 to 35%) may be adapted to meet the requirements of high speed coaters by adding a minor amount of a calcium carbonate pigment or a mixture of calcium carbonate and alumina pigments to the formulation, provided the binder-to-pigment dry weight ratio ranges from about 1:8 to about 1:1. In addition to being suitable for use with high speed coaters, the coating formulations of the present invention produce ink jet receptive layers which demonstrate good printability and which provide images having excellent water and humidity resistance and high image densities, rendering them suitable for use in wide format printing applications. In a preferred embodiment, the ink jet receptive layers further demonstrate good light or fade resistance.

Suitable porous organic pigments for use as the first pigment in the pigment composition of the coating formulation used to prepare the ink jet receptive layer of the present invention include acrylic resins such as polymethyl methacrylate, polymethylacrylate, polyacrylonitrile, poly(vinylpolypyrrolidone), styrene resins such as polystyrene, polymethylstyrene and the like, as well as styrene-acrylic resins, urea-formaldehyde resins, polyvinyl chlorides, polycarbonates, etc. Suitable porous inorganic pigments include porous alumina, porous sodium aluminosilicate, porous calcium carbonate, porous clays, porous magnesium carbonate, porous synthetic amorphous silica and the like.

The average diameter of pores in the porous organic and inorganic pigments is preferably from about 1 to about 800 nanometers, while the volume of pores in these pigments is preferably from about 0.4 to about 3.0 cubic centimeters per gram (cc/g).

Metal oxide gels, suitable for use as the first pigment in the pigment composition of the subject coating formulation include alumina gels, silica gels, polymeric gels such as melamine formaldehyde (M-F) gels, phenol-furfural (P-F) gels, resorcinol-formaldehyde (R-F) gels, urea-formaldehyde (U-F) gels, titania gels and the like.

In a preferred embodiment, the first pigment is a metal oxide gel. In yet a more preferred embodiment, the metal oxide gel is a silica gel having a surface area ranging from about 200 to about 800 square meters per gram (m²/g), a pore volume ranging from about 0.4 to about 3.0 cc/g, an average particle size ranging from about 1 to about 17 microns (μ) and a pH ranging from about 2.5 to about 10.5.

Specific preferred examples of silica gels having surface areas, pore volumes, average particle sizes and pHs falling within the ranges specified above, include SYLOID 620 and 234 wax-free silica gels, SYLOID 7000 wax surface-treated silica gels and SYLOID 74 (grade 4500, 5500 and 6500) silica gels, marketed by Grace Davison, W.R. Grace & Co., 7500 Grace Drive, Columbia, Md. 21044 (“Grace Davison”).

The first pigment is present in the pigment composition in an amount greater than or equal to 50% by dry wt., preferably from about 65 to about 90% by dry wt., and more preferably from about 80 to about 90% by dry wt., based on the total dry weight of the pigment composition.

The pigment composition of the coating formulation of the present invention also contains a porous or non-porous second pigment which appears to aid in the preservation or maintenance of an open structure in the ink jet receptive layer, upon drying, even at high binder-to-pigment dry weight ratios. The second pigment is selected from the group including calcium carbonate and mixtures of calcium carbonate and alumina.

In a preferred embodiment, the second pigment is calcium carbonate and, more preferably, is a precipitated calcium carbonate (PCC) pigment possessing a surface area ranging from about 10 to about 300 square meters per gram (m²/g) (preferably from about 30 to about 200 m²/g, and more preferably from about 50 to about 120 m²/g), a particle size ranging from about 0.1 to about 5μ and rheology of a thixotropic nature thus facilitating application of the resulting coating formulation under high shear conditions.

Specific examples of PCCs possessing rheology of a thixotropic nature are available from Minerals Technologies Inc., 35 Highland Avenue, Bethlehem, Pa. 18017, under the trade designation JETCOAT 30 precipitated calcium carbonate, and from Fitz Chem Corporation, 185 Industrial Drive, Elmhurst, Ill. 60126-1601, under the trade designation MAGNUM GLOSS precipitated calcium carbonate.

In another preferred embodiment, the second pigment is a mixture comprising from about 60 to about 99% by dry wt. (and more preferably from about 80 to about 95% by dry wt.) of calcium carbonate and from about 40 to about 1% by dry wt. (and more preferably from about 20 to about 5% by dry wt.) of an alumina pigment.

Anhydrous alumina and alumina hydrate pigments are preferred. As the anhydrous alumina there may be used any of the various crystalline alumina such as α-alumina, β-alumina and γ-alumina. As the alumina hydrate there may be used either alumina monohydrate or trihydrate. Examples of the alumina monohydrate include pseudoboehmite, boehmite and diaspore. Examples of the alumina trihydrate include gibbsite and bayerite. Preferred among these alumina pigments is alumina trihydrate.

The average particle diameter of the alumina pigment to be used herein is preferably from about 0.1 to about 3.0μ, more preferably from about 0.4 to about 2.0μ. The alumina pigment to be used herein may or may not be porous but is preferably porous. The average diameter of pores in the particulate alumina pigment is preferably from about 0.5 to about 300 nanometers. The volume of pores in the particulate alumina pigment is preferably from about 0.1 to about 2.1 cc/g.

The second pigment is present in the pigment composition in an amount less than 50% by dry wt., preferably from about 35 to about 10% by dry wt., and more preferably from about 20 to about 10% by dry wt., based on the total dry weight of the pigment composition.

The subject pigment composition may contain additional components including, but not limited to, barium sulfate, clays, talc, titanium dioxide, zinc oxide and mixtures thereof.

The pigment composition is present in the coating formulation in an amount ranging from about 45 to about 85% by dry wt., preferably from about 50 to about 80% by dry wt., based on the total dry weight of the coating formulation.

The water-soluble binder of the coating formulation of the present invention is preferably selected from the group including super, fully and partially hydrolyzed polyvinyl alcohols and mixtures thereof and, optionally, one or more cationic acrylic resins.

The term “super hydrolyzed,” as used herein, is intended to refer to those polyvinyl alcohols having a % hydrolysis ranging from about 99 to about 100, while the term “fully hydrolyzed” refers to a % hydrolysis ranging from about 97 to about 99. The term “partially hydrolyzed,” on the other hand, denotes a polyvinyl alcohol having a % hydrolysis of from about 70 to about 96.

The super hydrolyzed polyvinyl alcohols of the present invention preferably have a % hydrolysis of from about 99.3 to about 99.6, while the fully hydrolyzed polyvinyl alcohols preferably have a % hydrolysis of from about 98 to about 98.8. The partially hydrolyzed polyvinyl alcohols preferably have a % hydrolysis of from about 84 to about 92.

The super, fully and partially hydrolyzed polyvinyl alcohols of the water-soluble binder have medium-to-low molecular weights which range from about 5,000 to about 186,000 (preferably from about 13,000 to about 150,000) and may be modified by adding a cation thereto. More specifically, the polyvinyl alcohols may be modified by silanol, carboxy and/or quaternary amine groups.

Specific preferred examples of super, fully and partially hydrolyzed, medium-to-low molecular weight, polyvinyl alcohols are available from Air Products and Chemicals, Inc., 7201 Hamilton Blvd., Allentown, Pa. 18196-1501 (“Air Products”) and are sold under the trade designations AIRVOL 125 super hydrolyzed, medium molecular weight, polyvinyl alcohol, AIRVOL 325 fully hydrolyzed, medium molecular weight, polyvinyl alcohol, AIRVOL 523 partially hydrolyzed, medium molecular weight, polyvinyl alcohol and AIRVOL 205 partially hydrolyzed, low molecular weight, polyvinyl alcohol.

The water-soluble binder may further comprise from about 1 to about 50% by dry wt., based on the total dry weight of the water-soluble binder, of a cationic acrylic resin. The cationic acrylic resin serves to fix ink jet dyes and appears to enhance the color range or gamut of printed media. Suitable examples of such cationic acrylic resins include cationic styrene-acrylic resins, cationic styrene-acrylic copolymers, amide-modified cationic styrene-acrylic resins and cationic vinyl acrylic resins. Preferred cationic acrylic resins are cationic styrene-acrylic copolymers, which are available from Westvaco Corporation, Chemical Division, P.O. Box 70848, Charlestown Heights, S.C. 29415, and are sold under the trade designation TRUDOT P2605 cationic styrene-acrylic copolymers.

The water-soluble binder may contain additional components (e.g., alginate, biocides, casein, cellulose derivatives, CMC, hydroxymethyl cellulose, hydroxypropyl cellulose, water soluble gums, latex, amphoteric latex, maleic anhydride resins, melamine resins, polyacrylamide resins, polyester resins, polyvinyl acetate, polyvinyl pyrrolidone, polyvinyl pyrrolidone vinyl acetate copolymers, modified starch, ethoxylated starch, cationic starch, oxidized starch and blends thereof) provided any such additional components(s) does not adversely impact upon the desirable properties of the binder.

In a more preferred embodiment, the water-soluble binder comprises:

(a) from about 10 to about 90% by dry wt. (more preferably from about 20 to about 80% by dry wt.) of a super hydrolyzed, medium viscosity polyvinyl alcohol;

(b) from about 10 to about 70% by dry wt. (more preferably from about 15 to about 65% by dry wt.) of a partially hydrolyzed, medium viscosity polyvinyl alcohol; and

(c) from about 0 to about 20% by dry wt. (more preferably from about 5 to about 15% by dry wt.) of a partially hydrolyzed, low viscosity polyvinyl alcohol.

The water-soluble binder preferably has a medium-to-low viscosity. More specifically, the binder has a preferred viscosity ranging from about 3 to about 40 centipoise (cps), as measured by a Brookfield Viscosimeter, model number DV-II+, using a 4% polyvinyl alcohol aqueous solution at 20° C.

The binder/pigment dry weight ratio in the coating formulation used to prepare the ink jet receptive layer of the present invention ranges from about 1:8 to about 1:1, preferably ranges from about 1:6 to about 1:1.5, and more preferably ranges from about 1:2.8 to about 1:1.8.

The present inventor has found that if the binder/pigment ratio exceeds 1:1 (i.e., the binder is present in an amount which is greater than the amount of pigment), an increase in the degree of wicking and intercolor bleeding will be observed, while if the ratio falls below 1:8 (i.e., the binder is present in an amount which is less than 12.5% of the amount of pigment), a decrease in optical or image densities will be observed.

The water-soluble binder is present in the coating formulation in an amount ranging from about 10 to about 45% by dry wt., preferably from about 15 to about 40% by wt., based on the total dry weight of the coating formulation.

The coating formulation of the present invention, in a more preferred embodiment, comprises: (a) a pigment composition comprising greater than or equal to 50% by dry wt., based on the total dry weight of the pigment composition, of a silica gel, and less than 50% by dry wt., based on the total dry weight of the pigment composition, of a second pigment selected from the group of calcium carbonate and mixtures of calcium carbonate and alumina; and (b) a water-soluble binder selected from the group of super, fully and partially hydrolyzed polyvinyl alcohols and mixtures thereof and, optionally, one or more cationic acrylic resins, wherein, the binder/pigment dry weight ratio in the coating formulation ranges from about 1:8 to about 1:1.

In yet a more preferred embodiment, the inventive coating formulation comprises: (a) a pigment composition comprising from about 65 to about 90% by dry wt. (more preferably from about 80 to about 90% by dry wt.), based on the total dry weight of the pigment composition, of a silica gel, and from about 35 to about 10% by dry wt. (more preferably from about 20 to about 10% by dry wt.), based on the total dry weight of the pigment composition, of a precipitated calcium carbonate pigment having a surface area ranging from about 30 to about 200 m²/g (more preferably from about 50 to about 120 m²/g) and a particle size ranging from about 0.1 to about 5μ; and (b) a water-soluble binder selected from the group of super, fully and partially hydrolyzed polyvinyl alcohols and mixtures thereof, wherein, the binder/pigment dry weight ratio in the coating formulation ranges from about 1:6 to about 1:1.5.

The coating formulation of the present invention may further comprise a cationic resin, which serves as a fixing agent of ink and improves the fixing of recorded images and water resistance.

Preferred cationic resins include polyvinyl benzyl trimethyl ammonium chloride, polydiallyl dimethyl ammonium chloride, polymethacryloxyethyl hydroxy ethyldiammonium chloride, quaternary acrylic copolymer latex, amidoepichlohydrin copolymer, dimethylaminoethylmethacrylate copolymer, dimethyldiallylammonium chloride acrylamide copolymer, dimethyldiallylammonium chloride sulfur dioxide copolymer, vinyl pyrrolidone dimethylaminoethylmethacrylate copolymer, polyallylamine, polyvinylamine, vinyl amine acrylonitrile copolymers, polyalkylene imine polymers, polyalkylene polyamine polymers, polyalkylene polyamide dicyandiamide copolymers, polyamide dicyandiamide copolymers, quaternary ammonium polymers and blends thereof. In a preferred embodiment, the cationic resin is a quaternary ammonium polymer and, more preferably, is polydiallyl dimethyl ammonium chloride marketed by Calgon Corporation, 2015 Christine Drive, Harleysville, Pa. 19438 under the trade designation CP-1030.

The cationic resin is preferably present in the coating formulation in an amount ranging from about 1 to about 25% by dry wt., preferably from about 3 to about 15% by dry wt., based on the total dry weight of the coating formulation.

An optionally fluorescent whitening agent may also be added to the coating formulation of the present invention to increase the whiteness, brightness and bluish shade of the resulting ink jet recording material. Examples of such whitening agents include disulfonated, tetrasulfonated and hexasulfonated stilbene derivatives. In a preferred embodiment, the agent is a hexasulfonated stilbene derivative, which is available from Ciba Specialty Chemical Corp., 540 White Plains Road, Tarrytown, N.Y. 10591 (“Ciba Specialty”), under the product designation TINOPAL ABP-A, and is preferably present in an amount ranging from about 0.01 to about 1.5% by dry wt., preferably from about 0.1 to about 0.8% by dry wt., based on the total dry weight of the coating formulation.

The whitening agent may employ a fluorescing agent, which absorbs energy in the UV region and emits light largely in the blue region.

A blueing dye may also be added to the inventive coating formulation to increase the whiteness of the resulting ink jet recording material. Suitable examples of such dyes include cobalt blue, copper phthalocyanine, metal-free phthalocyanine, oxide cobalt phosphate, dye complex salts (i.e., dyes precipitated with phosphomolybdic, phosphotungstic, phospho-molybdotungstic acids), quinacridone pigments, ultramarine blue and mixtures thereof. Preferred blueing dyes have good lightfastness and are available from: Ciba Specialty, under the product designations IRGALITE BLUE RL PST copper phthalocyanine dyestuff dispersion and IRGALITE VIOLET RM and IRGALITE RED B-FL arylamide pigment dispersions; and Bayer Industrial Chemicals, under the product designations PONOLITH RED WC quinacridone pigment dispersion and PONOLITH BLUE RDC copper phthalocyanine pigment dispersion. Blueing dyes are preferably present in the coating formulation in amounts ranging from about 0.001 to about 0.05% by dry wt., more preferably from about 0.002 to about 0.007% by dry wt., based on the total dry weight of the coating formulation.

It is noted that when both the optionally fluorescent whitening agent and the blueing dye are present in the coating formulation, the whitening agent/blueing dye weight ratio preferably ranges from about 1:1 to about 1000:1, and more preferably ranges from about 2:1 to about 800:1. If the whitening agent/blueing dye ratio falls below 1:1, the resulting ink jet recording material displays lower brightness and whiteness, and if the ratio exceeds 1000:1, the resulting recording materials demonstrates poor lightfastness.

In addition to the above components, the coating formulation of the present invention can advantageously contain other additives such as antioxidants, antistatic agents, crosslinking agents, defoaming agents, dispersing agents, fragrances, mold inhibitors, slip agents, UV absorbers and wetting agents. However, some such additives may adversely impact upon the desirable properties of the resulting ink jet receptive layer.

The coating formulation, in yet a more preferred embodiment of the present invention, comprises:

(i) from about 45 to about 85% by dry wt. (more preferably from about 50 to about 80% by dry wt.), based on the total dry weight of the coating formulation, of a pigment composition comprising from about 65 to about 90% by dry wt. (more preferably, from about 80 to about 90% by dry wt.), based on the total dry weight of the pigment composition, of a silica gel, and from about 35 to about 10% by dry wt. (more preferably, from about 20 to about 10% by dry wt.), based on the total dry weight of the pigment composition, of a precipitated calcium carbonate pigment having a surface area ranging from about 30 to about 200 m²/g (more preferably, from about 50 to about 120 m²/g) and a particle size ranging from about 0.1 to about 5μ,

wherein, the sum of the pigment composition components total 100% by dry wt.;

(ii) from about 10 to about 45% by dry wt. (more preferably, from about 15 to about 40% by dry wt.), based on the total dry weight of the coating formulation, of a water-soluble binder comprising:

(a) from about 20 to about 70% by dry wt., based on the total dry weight of the binder, of a super and/or fully hydrolyzed, medium molecular weight polyvinyl alcohol;

(b) from about 70 to about 25% by dry wt., based on the total dry weight of the binder, of a partially hydrolyzed, medium-to-low molecular weight, polyvinyl alcohol; and

(c) from about 5 to about 35% by dry wt., based on the total dry weight of the binder, of a cationic styrene acrylic copolymer;

(iii) from about 1 to about 25% by dry wt. (more preferably, from about 3 to about 15% by dry wt.), based on the total dry weight of the coating formulation, of a cationic resin (e.g., polydiallyl dimethyl ammonium chloride);

(iv) an effective amount (more preferably, from about 0.01 to about 1.5% by dry wt.) of an optionally fluorescent whitening agent (e.g., hexasulfonated stilbene derivative); and

(v) optionally, an effective amount (more preferably, from about 0.001 to about 0.05% by dry wt.) of a blueing dye (e.g., phthalocyanine dye stuff),

wherein, the sum of the coating formulation components total 100% by dry wt.,

wherein, the binder/pigment dry weight ratio in the coating formulation ranges from about 1:6 to about 1:1.5 (more preferably, from about 1:2.8 to about 1:1.8), and

wherein, when an optionally fluorescent whitening agent and a blueing dye are present in the coating formulation, the optionally fluorescent whitening agent/blueing dye weight ratio in the formulation ranges from about 2:1 to about 800:1.

The ink jet receptive layer coating formulation is made by mixing the components with water so as to obtain an aqueous coating formulation having a solids content ranging from about 15 to about 35% (preferably, from about 20 to about 30%), based on the total dry weight of the coating formulation. The pH of the aqueous coating formulation is between 6 and 10, and preferably is between 6.5 and 8.

In a preferred embodiment, the coating formulation is made by adding the pigments and the binder to water in the following order of addition: the second pigment, the binder, the first pigment. For those formulations also containing a cationic resin and/or a dispersing agent, the cationic resin and/or dispersing agent is/are preferably added before the first pigment. These sequences of addition are preferred because they allow for the dispersion of silica at higher solids and at relatively lower viscosities, than otherwise possible. For those formulations employing a cationic resin in combination with an optionally fluorescent whitening agent, the formulation is preferably made by adding the components in the following order of addition: water, the cationic resin, the second pigment, the optionally fluorescent whitening agent, the dispersing agent, the binder, the first pigment, the remaining ingredients or components. This sequence of addition is preferred where the cationic resin is somewhat incompatible with the optionally fluorescent whitening agent but aids in the dispersion of the first pigment.

The aqueous coating formulations of the present invention have a Brookfield viscosity of from about 100 to about 1800 cps (preferably from about 300 to about 1500 cps) (at 21° C., 100 rpm, from about 15 to about 35% aqueous solution), and a high shear Hercules viscosity of from about 10 to about 50 cps (preferably from about 15 to about 40 cps), at 8800 rpm, using an F2.5 bob, and may be applied to a substrate (e.g., paper) using e.g., air knife or blade coaters, rod coaters or gravure coaters. Drying can be accomplished by any known method or technique including room temperature air drying, hot air drying, heating surface-contact drying or heat radiation drying.

In order to avoid degradation in ink absorptivity caused by the use of excessive amounts of coating, it is preferred that the ink jet coating formulation of the present invention be applied so as to achieve an average coat weight that ranges from about 2 to about 14 g/m², based on the total dry weight of the coating formulation.

Substrates useful in the present invention are coatable substrates, examples of which include, without limitation, paper, cardboard, corrugated board, plastic film, metal film, foil face stocks and label stocks.

The substrate preferably has a thickness ranging from about 50 to about 300μ, a basis weight ranging from about 40 to about 240 grams per square meter (g/m²), a surface smoothness of from about 15 to about 150 Bekk seconds and a Cobb sizing of from about 25 to about 150 g/m².

The ink jet recording material of the present invention may further include one or more undercoat layers, which serve to reduce cockling and enhance or improve the whiteness, brightness, opacity, ink jet ink strike-through and lightfastness of the resulting recording material.

When an undercoat layer is employed, the amount of optionally fluorescent whitening agent in the undercoat layer is greater than the amount of whitening agent in the ink receptive layer.

The present inventor has discovered that by using quantities of whitening agents in an undercoat layer, where such quantities are greater than the quantities of whitening agents used in the overlying ink jet layer, the resulting recording material will demonstrate high brightness and whiteness and light or fade resistance. As will be readily evident to those skilled in the art, use of an undercoat layer in the present invention allows for the use of less expensive grades of substrates (e.g., base papers) where such substrates no longer have to satisfy rigid brightness/whiteness standards.

The coating formulation used to prepare the undercoat layer, comprises:

(i) one or more pigments;

(ii) one or more binders;

(iii) optionally, one or more dispersing agents; and

(iv) an effective amount of an optionally fluorescent whitening agent.

Pigments useful in the undercoat layer include materials that increase the opacity, and/or modify the porosity of the coated substrate. Inorganic pigments are especially preferred and include, without limitation, alumina (e.g., alumina trihydrate), salts of alkaline earth metals (e.g., sulfonates such as barium sulfate), clays, satin white, titanium oxide and the like.

Alumina pigments are described in detail above.

Salts of alkaline earth metals include sulfonates and carbonates such as barium sulfate, magnesium sulfate and calcium carbonate.

In a preferred embodiment, the coating formulation used to prepare the undercoat layer comprises from about 50 to about 95% by dry wt., based on the total dry weight of the coating formulation, of one or more inorganic pigments, and more preferably comprises from about 70 to about 90% by dry wt. of alumina trihydrate.

Binders suitable for use in the undercoat layer are water-soluble polymeric materials, examples of which include casein, cellulose derivatives, gelatin, polyvinyl alcohol, modified polyvinyl alcohol, latex, starch, starch derivatives, styrene-acrylic copolymers, ethylene-maleic anhydride copolymer and styrene-maleic anhydride copolymer. Among the listed materials, polyvinyl alcohols are preferably used in the coating formulation.

Preferably, the binder is employed in the coating formulation at levels ranging from about 50 to about 5% by dry wt., more preferably from about 28 to about 7% by wt., based on the total dry weight of the coating formulation.

The pigment/binder ratio in the coating formulation used to prepare the undercoat layer ranges from about 1:1 to about 20:1, and preferably ranges from about 2.5:1 to about 13:1. The present inventor has found that if the pigment/binder ratio falls below 1:1, a reduction in brightness, whiteness, opacity and printed image quality results, while coating surface strength is reduced if the ratio exceeds 20:1.

Suitable dispersing agents include acrylic acid copolymer salts, aluminum stearate, calcium palmitate, polyphosphates such as sodium hexametaphosphate, sodium laurate, sodium palmitate, sodium stearate, etc. Preferred dispersing agents are acrylic acid copolymer salts, while more preferred dispersing agents are ammonium acrylic acid copolymer salts. These dispersing agents give good whiteness to the undercoat layer.

In a preferred embodiment, a dispersing agent is present in the coating formulation at a concentration ranging from about 0.5 to about 5% by dry wt., more preferably from about 1 to about 4% by wt., based on the total dry weight of the coating formulation.

Suitable optionally fluorescent whitening agents are described hereinabove. In a preferred embodiment, the coating formulation used to prepare the undercoat layer comprises from about 0.1 to about 1.5% by dry wt.), based on the total dry weight of the coating formulation, of an optionally fluorescent whitening agent, and preferably comprises from about 0.2 to about 1.0% by dry wt. of a stilbene fluorescent whitening agent.

In addition to the above components, the undercoat layer coating formulation of the present invention can advantageously contain other additives such as antioxidants, antistatic agents, cationic resins, crosslinking agents, defoaming agents, fragrances, inorganic dyestuffs, mold inhibitors, organic dyestuffs, slip agents, UV absorbers and wetting agents. However, some such additives may adversely impact upon the desirable properties of the resulting undercoat layer.

In a more preferred embodiment, the coating formulation used to prepare the undercoat layer of the present invention comprises:

(i) from about 70 to about 90% by dry wt., based on the total dry weight of the coating formulation, of alumina trihydrate pigment;

(ii) from about 7 to about 28% by dry wt., based on the total dry weight of the coating formulation, of polyvinyl alcohol copolymer;

(iii) from about 1 to about 4% by dry wt., based on the total dry weight of the coating formulation, of an ammonium acrylic acid copolymer salt; and

(iv) from about 0.2 to about 1.0% by dry wt., based on the total dry weight of the coating formulation, of a stilbene fluorescent whitening agent,

wherein, the sum of the coating formulation components total 100% by wt., and

wherein, the pigment/binder ratio in the undercoat layer ranges from about 2.5:1 to about 13:1.

The undercoat layer coating formulation is prepared by mixing the components with water so as to obtain an aqueous composition having a preferred solids content ranging from about 15 to about 50%, based on the total dry weight of the coating composition.

In a preferred embodiment, the undercoat layer coating formulation is made by adding each component to a quantity of water contained in a mixing tank in the following order: the dispersing agent, the pigment, the binder, and the optionally fluorescent whitening agent, allowing sufficient time between additions to provide for complete mixing.

It is preferred that the undercoat layer coating composition be applied so as to achieve an average coat weight that ranges from about 2 to about 12 g/m², based on the total dry weight of the coating composition.

The ink jet recording material of the present invention may also contain one or more backcoat layers. The backcoat layer(s), which serves to reduce the degree of cockling and curl in the recording material upon drying, is prepared using a coating formulation which comprises: a binder (e.g., polyvinyl alcohol) or a pigment/binder blend, and optionally other additives such as antioxidants, antistatic agents, cationic resins, crosslinking agents, defoaming agents, dispersing agents (e.g., acrylic acid copolymer salts), fragrances, inorganic dyestuffs, mold inhibitors, organic dyestuffs, slip agents, surfactants (e.g., octyl phenoxy ethanol), UV absorbers, wetting agents and fluorescent whitening agents.

In one embodiment, the coating formulation used to prepare the backcoat layer(s) is a non-pigmented coating composition, which comprises:

(i) from about 45 to about 95% by dry wt., based on the total dry weight of the coating formulation, of a polyvinyl alcohol binder;

(ii) from about 5 to about 30% by dry wt., based on the total dry weight of the coating formulation, of an acrylic acid copolymer salt dispersing agent; and

(iii) from about 5 to about 35% by dry wt., based on the total dry weight of the coating formulation, of an octyl phenoxy polyethoxy ethanol nonionic surfactant,

wherein, the sum of the coating formulation components total 100% by dry weight.

The subject composition is prepared by mixing the components with water so as to obtain an aqueous composition having a solids content ranging from about 1 to about 10% by dry wt., based on the total dry weight of the coating formulation. The formulation is applied so as to achieve an average coat weight that ranges from about 2 to about 14 g/m², based on the total dry weight of the coating formulation.

In a more preferred embodiment, the coating formulation is a pigmented formulation similar, if not identical, to that described above for use in preparing the undercoat layer. The aqueous coating formulation has a higher solids content ranging from about 20 to about 50% by wt., and is applied so as to achieve an average coat weight that ranges from about 3 to about 8 g/m².

As will be readily evident to those skilled in the art, pigmented backcoat layers serve to increase opacity, brightness and whiteness, in addition to, reducing or further reducing cockle and curl.

In yet a more preferred embodiment, the ink jet recording material of the present invention comprises an outer backcoat layer, which provides a surface for off-set printing.

A number of different layer constructions for the ink jet recording material of the present invention are contemplated, several of which are identified below:

(a) substrate/ink jet receptive layer(s) or (I);

(b) substrate/undercoat layer(s)/ink jet receptive layer(s) or (II);

(c) substrate/backcoat layer(s)/ink jet receptive layer(s) or (III);

(d) substrate/undercoat layer(s)/backcoat layer(s)/ink jet receptive layers(s) or (IV);

(e) substrate/backcoat layer(s)/undercoat layer(s)/ink jet receptive layer(s) or (V);

(f) backcoat layer(s)/(I), (II), (III), (IV) or (V);

(g) ink jet receptive layer(s)/(I), (II), (III), (IV) or (V);

(h) ink jet receptive layer(s)/undercoat layer(s)/(I), (II), (III), (IV) or (V);

(i) ink jet receptive layer(s)/backcoat layer(s)/(I), (II), (III), (IV) or (V);

(j) ink jet receptive layer(s)/backcoat layer(s)/undercoat layer(s)/(I), (II), (III), (IV) or (V); and

(k) ink jet receptive layer(s)/undercoat layer(s)/backcoat layer(s)/(I), (II), (III), (IV) or (V).

The ink jet recording material of the present invention demonstrates good printability and provides images having excellent water and humidity resistance and high image densities.

In a more preferred embodiment of the present invention, the ink jet recording material has high background brightness and whiteness, demonstrates good printability and good light or fade resistance and provides images having excellent water and humidity resistance and high image densities.

The subject invention will now be described by reference to the following illustrative examples. The examples are not, however, intended to limit the generally broad scope of the present invention.

### WORKING EXAMPLES

### Components used

In the working examples set forth below, the following components were used:

| | |
|---|---|
| SILICA | a silica gel having a pore volume of 1.2 cc/g and an average particle size of |
| GEL | 5.3μ marketed by Grace Davison under the trade designation SYLOID |
| | 74 × 6500 silica gel. |
| PCC | a precipitated calcium carbonate water-based dispersion supplied at 25.5% |
| | solids, marketed by Specialty Minerals Technologies Inc., 35 Highland |
| | Avenue, Bethlehem, PA 18017, under the trade designation JETCOAT 30 |
| | precipitated calcium carbonate. |
| BINDER | a blend of the following components: |
| | 1. 39.80% by wt. (dry) of a super hydrolyzed, medium viscosity |
| | polyvinyl alcohol marketed by Air Products under the trade |
| | designation AIRVOL 125 polyvinyl alcohol; |
| | 2. 35.40% by wt. (dry) of a partially hydrolyzed, medium |
| | viscosity polyvinyl alcohol marketed by Air Products under the |
| | trade designation AIRVOL 523 polyvinyl alcohol; |
| | 3. 7.08% by wt. (dry) of a partially hydrolyzed, low viscosity |
| | polyvinyl alcohol marketed by Air Products under the trade designation |
| | AIRVOL 205 polyvinyl alcohol; |
| | 4. 17.70% by wt. (dry) of a cationic starch marketed by National |
| | Starch and Chemical Co., 10 Finderne Ave., P.O. Box 6500, |
| | Bridgewater, N.J. 08807 under the trade designation |
| | CATO SIZE 240A cationic starch; and |
| | 5. 0.02% by wt. (dry) of a biocide marketed by Calgon Corporation, |
| | under the trade designation TEKTAMER 38 LV 1,2-dibromo-2,4- |
| | dicyanobutane aqueous dispersion. |
| | The BINDER was prepared by: adding the above-identified components, in |
| | solid form, to a mixing tank containing water; heating the resulting mixture, by |
| | steam injection, to approximately 96° C.; maintaining that temperature for 30 |
| | minutes; cooling the mixture to a temperature below 38° C.; and then |
| | adjusting the solids content to about 10% by wt. |
| CATIONIC | a cationic styrene-acrylic copolymer water-based emulsion supplied at 40% |
| ACRYLIC | solids, marketed by Westvaco Corporation, under the trade designation |
| RESIN | TRUDOT P2605 cationic styrene-acrylic copolymers. |
| CATIONIC | a quaternary ammonium polymer (poly(dimethyldiallylammonium chloride)) |
| RESIN | supplied as a water-based solution at 33.5% solids, marketed by Calgon |
| | Corporation under the trade designation CP-1030 quaternary ammonium |
| | polymer. |
| FWA | a stilbene fluorescent whitening agent supplied as a water-based solution at |
| | 29% solids, marketed by Ciba Specialty Chemicals Corporation, North |
| | America, 4090 Premier Drive, High Point, NC 27261, under the trade |
| | designation TINOPAL ABP-A stilbene fluorescent whitening agent. |
| BLUEING | a water-based blueing pigment dye marketed by Ciba Specialty |
| DYE I | Chemicals Corporation, under the trade designation IRGALITE BLUE RL |
| | water-based blueing pigment dye. |
| BLUEING | a water-based blueing pigment dye marketed by Bayer Industrial Chemicals, |
| | 100 Bayer Road, Pittsburgh, PA 15205, under the trade designation |
| | PONOLITH RED WC water-based blueing pigment dye. |
| WETTING | an ethoxylated acetylenic diol surfactant marketed by Air Products under |
| AGENT | the trade designation SURFYNOL 465 ethoxylated acetylenic diol surfactant. |
| DISPERSING | a water based solution of a high molecular weight block copolymer with |
| AGENT | anionic/non ionic groups marketed by BYK-Chemie USA, 524 South Cherry |
| | Street, Wallingford, Connecticut 06492, under the trade designation |
| | DISPERBYK 190 dispersing and wetting agent. |

### Sample Preparation and Test Methods

1. Preparation of Aqueous Coating Formulations for Ink Jet Receptive Layers.

Aqueous coating formulations for use in making the ink jet receptive layers were prepared by adding the components identified below in Table 1A, to a mixing tank in the quantities specified. The pigment compositions used for each coating formulation are further described in Table 1B.

TABLE 1A
Coating Formulations for Ink Jet Receptive Layers

| Components | Aqueous Coating Formulation | | | | | | |
|---|---|---|---|---|---|---|---|
| (parts by weight) | I | II | III | IV | V | VI | VII |
| SILICA GEL | 34.6 | 119.6 | 112.9 | 106.3 | 119.6 | 112.9 | 106.3 |
| PCC | 124.8 | 52.1 | 78.1 | 104.2 | 52.1 | 78.1 | 104.2 |
| BINDER¹ | 213.5 | 134.0 | 134.0 | 134.0 | 178.8 | 178.8 | 178.8 |
| CATIONIC ACRYLIC | 17.5 | 8.0 | 8.0 | 8.0 | 10.6 | 10.6 | 10.6 |
| RESIN | | | | | | | |
| CATIONIC RESIN | 14.7 | 29.5 | 29.5 | 29.5 | 29.5 | 29.5 | 29.5 |
| FWA | 0.78 | 1.56 | 1.56 | 1.56 | 1.56 | 1.56 | 1.56 |
| BLUEING DYE I² | 1.4 | 2.8 | 2.8 | 2.8 | 2.8 | 2.8 | 2.8 |
| BLUEING DYE II³ | 4.2 | 8.3 | 8.3 | 8.3 | 8.3 | 8.3 | 8.3 |
| WETTING AGENT⁴ | 0.5 | 1.1 | 1.1 | 1.1 | 1.1 | 1.1 | 1.1 |
| DISPERSING AGENT | — | 14.3 | 14.3 | 14.3 | 14.3 | 14.3 | 14.3 |
| WATER | 143.5 | 199.9 | 180.5 | 161.1 | 171.5 | 152.1 | 132.7 |
| BINDER/100 PARTS | 42.7 | 12.5 | 12.5 | 12.5 | 16.7 | 16.7 | 16.7 |
| PIGMENT⁵ | | | | | | | |
| BINDER/PIGMENT | 1/2.3 | 1/8.0 | 1/8.0 | 1/8.0 | 1/6.0 | 1/6.0 | 1/6.0 |
| RATIO⁶ | | | | | | | |
| % SOLIDS | 18.3 | 28.5 | 28.4 | 28.4 | 28.6 | 28.5 | 28.9 |

¹10% aqueous solution
²supplied at 24.9% solids, diluted 1:100 with water prior to using
³supplied at 20.5% solids, diluted 1:100 with water prior to using
⁴diluted 1:10 with water prior to using
⁵BINDER/100 PARTS PIGMENT = dry parts BINDER per 100 parts dry pigment
⁶BINDER/PIGMENT RATIO = dry parts BINDER/dry parts pigment

TABLE 1B
Pigment Compositions In Aqueous Coating
Formulations

| Pigment | | | | | | | |
|---|---|---|---|---|---|---|---|
| Composition | | | | | | | |
| (dry parts | | | | | | | |
| pigment per | Aqueous Coating | | | | | | |
| 100 parts total | Formulation | | | | | | |
| dry pigment) | I | II | III | IV | V | VI | VII |
| SILICA GEL | 52.1 | 90.0 | 85.0 | 80.0 | 90.0 | 85.0 | 80.0 |
| PCC | 47.9 | 10.0 | 15.0 | 20.0 | 10.0 | 15.0 | 20.0 |

For each formulation, the CATIONIC RESIN, PCC, FWA, DISPERSING AGENT, BINDER and SILICA GEL components were added to the mixing tank while the water contained within the tank was being agitated. Mixing was continued for 25 to 35 minutes and then the remaining components were added in the following order: CATIONIC ACRYLIC RESIN, BLUEING DYE I, BLUEING DYE II, and WETTING AGENT. Water was added to the resulting formulation so as to achieve a solids content ranging from 18.3 to 28.9%. The temperature of each coating formulation was maintained between 20 and 30° C.

2. Evaluation of Fluid Characteristics of Aqueous Coating Formulations.

Samples of the aqueous coating formulations were taken for Brookfield viscosity and Hercules high-shear viscosity testing.

Brookfield viscosity (RV type) was determined in accordance with the following procedure using a Brookfield Engineering Laboratories, Inc. Model RVF-100 Viscometer. The spindle used was either a # 3 or # 4 notched spindle, suitable for measuring viscosities in the range of from 100 to 1800 cps at 100 rpm. The sample was placed in a plastic container and conditioned to 21° C. prior to measuring. The spindle was introduced into the sample along a diagonal path to avoid trapping air, and was then brought into an upright position and threaded onto a screw on the viscometer shaft. The surface of the liquid sample was lined up with the middle of the spindle notch. The viscometer was then turned on, and set to a shear rate of 20, 50 or 100 rpm. Readings were taken until the values stabilized, and then a final reading was taken and recorded. Viscosities were calculated in cps by using a reference table supplied by the manufacturer. The reference table took into account the viscometer model, spindle and speed being used.

Hercules viscosity was measured using a Kaltec Scientific, Inc. DV-10 Hi-Shear Viscometer, which uses concentric cylinders (i.e., a rotating inner cylinder or “bob” and stationary outer cylinder or “cup”) to measure a fluid's resistance to flow and to determine its viscous behavior. For this test, the cup was installed into a cup holder located in the viscometer and locked in place by turning the cup clockwise until it stopped. An F2.5 bob was turned by hand clockwise onto the viscometer shaft until it was tight. A quantity of 100 milliliters of sample was then allowed to equilibrate to room temperature and a quantity of 27 milliliters of equilibrated sample poured into the cup. A fluid depth gauge was used to measure the quantity of sample being tested. The bob was then lowered into the cup until it stopped. The viscometer was turned on, and set to a pre-shear of 0, a ramp time of 20.4 seconds, a hold time of 0, and a maximum rpm of 8800. Rotation of the bob caused the fluid sample to flow, and its resistance imposed a shear stress on the inner wall of the cup. The ratio of shear stress to shear rate (i.e., viscosity) was measured in cps.

The viscosity test results are shown in Table 2 below.

TABLE 2
Fluid Characteristics of Aqueous Coating Formulations

| | Aqueous Coating Formulation | | | | | | |
|---|---|---|---|---|---|---|---|
| | I | II | III | IV | V | VI | VII |
| Brookfield Viscosity @ | 100 | 2300 | 1500 | 1500 | 2900 | 2000 | 1900 |
| 20 rpm (cps) | | | | | | | |
| Brookfield Viscosity @ | 120 | 1420 | 1000 | 940 | 1880 | 1320 | 1300 |
| 50 rpm (cps) | | | | | | | |
| Brookfield Viscosity @ | 100 | 1010 | 710 | 700 | 1420 | 1000 | 1010 |
| 100 rpm (cps) | | | | | | | |
| Hi-Shear Viscosity @ | 18.3 | 32.9 | 29.9 | 30.7 | 40.1 | 37.9 | 36.8 |
| 8800 rpm, bob F 2.5 | | | | | | | |
| (cps) | | | | | | | |
| Density (g/cm³) | 1.09 | 1.08 | 1.15 | 1.15 | 1.08 | 1.11 | 1.11 |
| % Solids | 18.3 | 28.5 | 28.4 | 28.4 | 28.6 | 28.5 | 28.9 |

The data shown in Table 2 demonstrates that the coating formulations of the present invention can be prepared at relatively high solid levels without rendering the coating formulation unsuitable for use with high speed coaters, which require high shear apparent viscosities generally greater than 10 but less than 50 cps and preferably within the range of 15 to 40 cps. More specifically, the inventive coating formulations can be prepared using gel-type silicas at relatively high solid contents and at suitable high shear viscosity levels, thereby allowing for higher coat weights in single or multi-pass high speed coating operations.

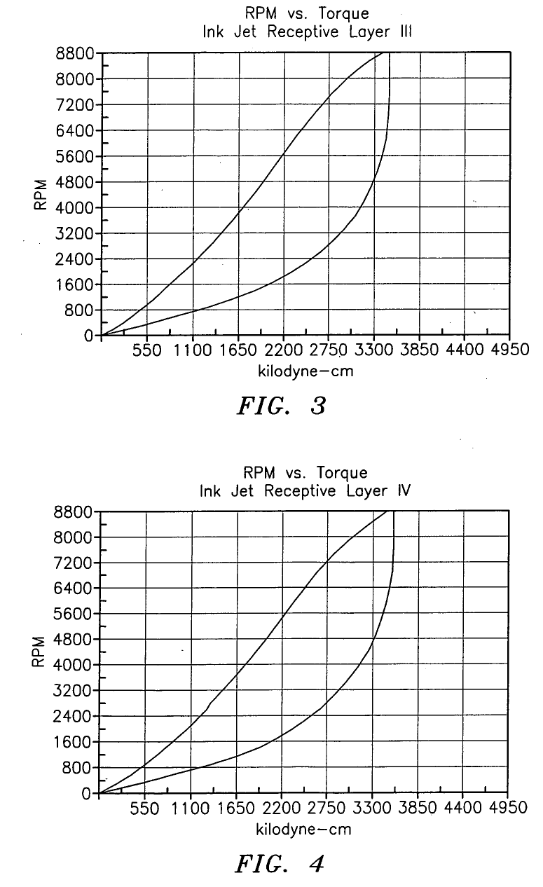

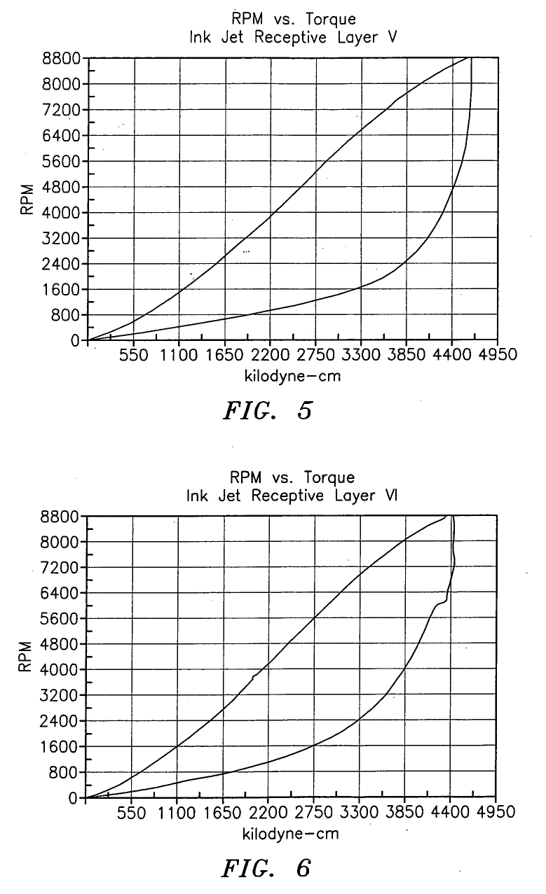

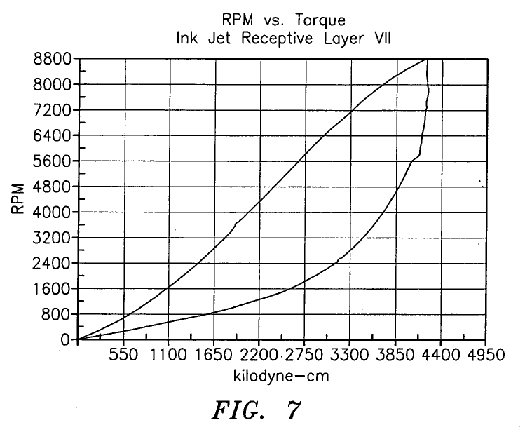

FIGS. 1 to 7 are rheograms, plotting torque as a function of RPM, for coating formulations I-VII, which are described in Tables 1A and 1B above. These figures amply demonstrate the advantageous pseudoplastic-thixotropic characteristics demonstrated by the aqueous coating formulation of the present invention.

Rheograms of thixotropic fluids are characterized by a hysteresis loop between the increasing shear rate (up) curve located on the right side and the decreasing shear rate (down) curve located on the left side of the rheogram. Shear thinning or pseudoplastic fluid characteristics are evidenced by a decrease in viscosity when the shear rate is increased. As is well known to those skilled in the art, shear thinning, thixotropic fluid characteristics are important in terms of coatability and fluid handling.

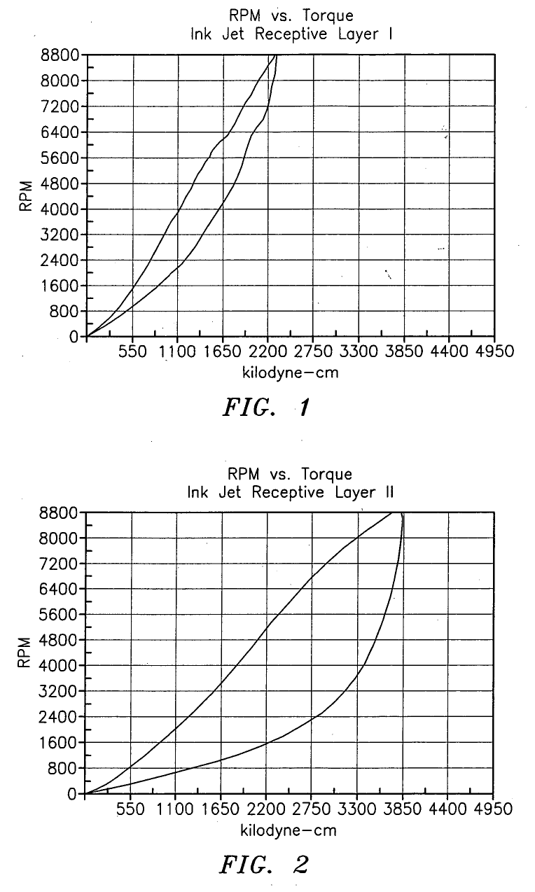

Referring now to the figures in detail, it will be observed that the inventive coating formulations may be tailored to match the requirements of high speed coaters by adjusting the pigment composition and/or the BINDER/PIGMENT RATIO. More specifically, FIGS. 2, 3 and 4 and FIGS. 5, 6 and 7 demonstrate that for coating formulations having similar BINDER/PIGMENT RATIOs, fluid characteristics are affected by the pigment composition, in that torque increases as the amount of SILICA GEL in the formulation increases, while FIGS. 2 and 5, 3 and 6, and 4 and 7 demonstrate that for coating formulations having similar pigment compositions, rheology properties may be adjusted by changing the BINDER/PIGMENT RATIO.

3. Formation of the Ink Jet Receptive Layer.

The aqueous coating formulations described in Tables 1A and 1B were applied directly to wood free base papers having a basis weight of 120 g/m² and a Cobb sizing of less than 80 g/m² (sold by Blue Ridge Paper Products Inc., under the trade designation 81 # Coating Base Hi-Brite, grade specification INK081WHI). The formulations were applied by means of Meyer rod # 12 to #18 (wire rod type) so as to achieve a coat weight of 8 g/m². The high solid coating formulations II to VII were diluted to about 26% solids prior to coating the base papers. The coated papers were then dried and calendared so as to achieve a smoothness in the range of 25 to 75 Bekk seconds.

4. Test Methods.

The coated ink jet papers were then subjected to several evaluation tests. Wide format printers manufactured by Encad, Inc., 6059 Cornerstone Court West, San Diego, Calif. 92121, and Hewlett Packard Co., 8000 Foothills Boulevard, Roseville, Calif. 95747, and sold under the trade designations NOVAJET 630 and HP 2500 CP, respectively, were used in conjunction with these tests. Narrow format printers manufactured by Hewlett Packard Co. and Seiko Epson Kabushiki Kaisha, and sold under the trade designations HP-940c and EPSON STYLUS 1270, respectively, were also used in conjunction with these tests.

The printers were used to print images on the coated ink jet papers using seven colors, namely—black, magenta, red, yellow, purple, green and cyan.

The NOVAJET 630 printer was set at premium matte, 100 gram, paper mode, Encad GS+ ink, ten pass (best) quality mode, stochastic dot pattern (600 dpi), while the HP 2500 CP printer was set at coated paper mode, HP dye ink, eight pass quality (enhanced) varware mode, bi-directional, stochastic dot pattern (600 dpi), prior to printing images on the coated papers.

Samples imaged using the HP-940c and the EPSON STYLUS 1270 narrow format printers used a test target, for each color tested. The HP-940c printer was set at premium ink jet paper, best mode, while the EPSON STYLUS 1270 printer was set at photo quality ink jet paper, automatic mode. The test targets were made using CORELDRAW 9 software, manufactured by Corel Corporation, 1600 Carling Avenue, Ottawa, Ontario, Canada. The color properties were defined by applying a CMYK model (i.e., the test print to measure optical densities defined each color as follows: Black (K:100), Magenta (M:100), Red (M:100, Y:100), Yellow (Y:100), Purple (M:100, C:100), Green (C:100, Y:100) and Cyan (C:100)).

Image Density

Image density is basically a measurement of the amount of light reflected by a sample. Image density is referred to as either optical density, color density or image density. Black, magenta, red, yellow, purple, green and cyan color densities were measured with an X-RITE 418 color densitometer, which is sold by X-Rite Corporation, 3100 44th Street Southwest, Grandville, Mich. 49418. Generally, in this test, a higher image density value denotes a higher strength of the measured color. A low image density may indicate either excessive dot gain control or penetration of the inks into the substrate.

Lightfastness (Background Light Stability)

Lightfastness refers to the durability or fade resistance of a coated paper when exposed to ultraviolet light. For this test, the coated test specimens were tested for brightness, whiteness and yellowness using a TECHNIBRITE MICRO TD 1C brightness meter, which is sold by Technidyne Corporation, 100 Quality Avenue, New Albany, N.Y. 47150, and the values recorded. L,a,b values were also determined and recorded. L,a,b values constitute a series of coordinates obtained from a calorimeter which describe any color as a set of three values. The “L” coordinate designates a value from light to dark, the “a” coordinate designates a value from red to green and the “b” coordinate designates a value from blue to yellow. These three numbers position any color in the 3 axis area and allows a comparison to be made to match any particular color standard.

The coated test specimens were then exposed to ultraviolet light (irradiance=0.35 W/m² at 340 nanometers) for 15 hours using an ATLAS fadeometer, Model No. CI 3000, which is sold by Atlas Electric Devices Company, 4114 North Ravenswood Avenue, Chicago, Ill. 60613, and brightness, whiteness and L,a,b values re-measured and recorded for each exposed sample.

ΔE values were then determined using the following equation:

ΔE=((Lᵢₙᵢₜᵢₐₗ−L_{UV exposed})²+(aᵢₙᵢₜᵢₐₗ−a_{UV exposed})²+(bᵢₙᵢₜᵢₐₗ−b_{UV exposed})²)^{0.5}

For this test, exposed test specimens having brightness values of greater than 88.5, whiteness values of greater than 92, b values of less than −1.8 and ΔE values of less than 3.5, were considered to have good lightfastness or background light stability.

It is noted that unexposed test specimens demonstrated average brightness values of greater than 93 average, whiteness values of greater than 112 and average b values of less than −5.

Waterfastness

Waterfastness refers to the resistance of an ink jet image to dilution or removal by water. In a waterfast, coated paper, inks have a reduced tendency to wick or feather. The coated test specimens were tested for waterfastness by (1) printing each test specimen with one of the designated printers, (2) measuring and recording the image densities of each color (i.e., black, magenta, red, yellow, purple, green and cyan) imaged on the printed samples, (3) immersing each printed sample in tap water for five minutes, (4) removing excess water from each sample using a paper towel, (5) drying each sample by placing the sample in a convection oven set at 110° C. for three minutes, (6) allowing each sample to cool down and equilibrate to room temperature, and (7) re-measuring and recording color densities for each printed test specimen.

Mottle

Mottle (P,F) refers to the visual uniformity of the printed area of the ink jet recording materials. A Pass (P) rating indicates that no visual non-uniformity was observed in the printed area, while a Fail (F) rating indicates that some visual non-uniformity was observed in the printed area that was not related to the base paper formation.

Wicking

Wicking performance, which is a measure of the degree of dot gain, was determined by inspecting non-printed areas of each sample between printed bands of a given color using an 8× magnifier. Wicking was rated as follows:

| Rating | Wicking Performance |
|---|---|
| 1 | none or minimal feathering - rated very good |
| 2 | low to medium feathering - rated good |
| 3 | medium to high feathering - rated fair/poor |
| 4 | very high degree of feathering - rated poor |

The reported wicking performance rating for each sample was the highest rating for the colors tested.

Intercolor Bleeding

For this test, a yellow background was printed on each test sample. Black and purple bands were then printed on the yellow background and the yellow areas between the black and purple bands inspected using an 8× magnifier. Intercolor bleeding was rated as follows:

| Rating | Intercolor Bleeding |
|---|---|
| 1 | none or minimal intercolor bleeding - rated very |
| | good |
| 2 | low to medium intercolor bleeding - rated good |
| 3 | medium to high intercolor bleeding - rated fair/poor |
| 4 | very high degree of intercolor bleeding - rated poor |

The reported wicking performance rating for each sample was the highest rating for the colors tested.

Humidity Resistance

The resistance of ink jet images to dilution or removal under high relative humidity conditions was determined by (1) printing each test specimen with one of the designated printers, (2) measuring and recording the image densities of each color imaged on the printed samples, (3) storing the printed samples in an atmosphere having a temperature of 40° C. and a relative humidity (RH) of 90% for 24 hours, (4) measuring and recording the remaining image densities of the imaged colors on each printed test specimen and (5) determining % change in image densities using the following equation:

% Change=(Image Density_{Exposed to 40° C., 90% RH}/Image Densityᵢₙᵢₜᵢₐₗ)×100

Low percentage Image Density changes (i.e., less than or equal to 110%) for each imaged color indicated good relative humidity stability or resistance.

### Examples 1 to 7

In these examples, the ink jet recording materials of the present invention were evaluated for lightfastness in accordance with the test procedure set forth herein. The results are shown in Table 3 below.

TABLE 3
Summary of Examples 1 to 7

| Ex- | Aqueous | Brightness | | Whiteness | | Yellowness | | |
|---|---|---|---|---|---|---|---|---|
| am- | Coating | | After | | After | | After | |
| ple | Formulation | Initial | UV | Initial | UV | Initial | UV | ΔE |
| 1 | I | 93.28 | 89.36 | 115.32 | 99.95 | −8.87 | −4.15 | 3.10 |
| 2 | II | 93.00 | 88.32 | 114.80 | 96.74 | −8.81 | −3.38 | 3.64 |
| 3 | III | 93.08 | 88.15 | 115.73 | 96.83 | −9.06 | −3.31 | 3.77 |
| 4 | IV | 93.01 | 88.49 | 114.58 | 97.47 | −8.72 | −3.47 | 3.36 |
| 5 | V | 93.11 | 88.52 | 115.07 | 97.18 | −8.91 | −3.39 | 3.52 |
| 6 | VI | 93.19 | 88.68 | 114.78 | 97.57 | −8.72 | −3.52 | 3.43 |
| 7 | VII | 93.11 | 88.78 | 114.56 | 97.68 | −8.86 | −3.51 | 3.33 |

The brightness, whiteness and light stability values recorded for Examples 1 to 7 indicate that the ink jet recording materials of the present invention are not significantly affected by either the pigment compositon (compare Examples 1, 2, 3 and 4 and compare Examples 1, 5, 6 and 7), nor the BINDER/PIGMENT RATIO (compare Examples 2 and 5, 3 and 6, and 4 and 7) used in the ink jet receptive layer.

### Examples 8 to 14

In these examples, the ink jet recording materials of the present invention were imaged using HP 2500 CP and NOVAJET 630 wide format printers and HP-940c and EPSON 1270 narrow format printers, and the image densities of the formed images measured and recorded. The results are set forth in Table 4, hereinbelow.

TABLE 4
Summary of Examples 8 to 14

| | Example | | | | | | |
|---|---|---|---|---|---|---|---|
| | 8 | 9 | 10 | 11 | 12 | 13 | 14 |
| Aqueous Coating | I | II | III | IV | V | VI | VII |
| Formulation | | | | | | | |
| BINDER/100 PARTS | 42.7 | 12.5 | 12.5 | 12.5 | 16.7 | 16.7 | 16.7 |
| PIGMENT¹ | | | | | | | |
| BINDER/PIGMENT | 1/2.3 | 1/8.0 | 1/8.0 | 1/8.0 | 1/6.0 | 1/6.0 | 1/6.0 |
| RATIO² | | | | | | | |
| Image Densities | | | | | | | |
| HP-2500 CP | | | | | | | |
| Black | 1.64 | 1.61 | 1.60 | 1.59 | 1.62 | 1.59 | 1.60 |
| Magenta | 1.49 | 1.54 | 1.51 | 1.48 | 1.53 | 1.49 | 1.47 |
| Red | 1.43 | 1.50 | 1.51 | 1.45 | 1.50 | 1.49 | 1.49 |
| Yellow | 0.94 | 0.87 | 0.86 | 0.85 | 0.88 | 0.86 | 0.86 |
| Purple | 1.62 | 1.64 | 1.63 | 1.60 | 1.64 | 1.63 | 1.61 |
| Green | 1.54 | 1.59 | 1.57 | 1.54 | 1.59 | 1.58 | 1.57 |
| Cyan | 1.56 | 1.56 | 1.53 | 1.51 | 1.55 | 1.55 | 1.53 |
| SUM | 10.22 | 10.31 | 10.21 | 10.02 | 10.31 | 10.19 | 10.13 |
| NOVAJET 630 | | | | | | | |
| Black | 1.78 | 1.65 | 1.66 | 1.62 | 1.67 | 1.65 | 1.64 |
| Magenta | 1.52 | 1.27 | 1.26 | 1.26 | 1.28 | 1.28 | 1.27 |
| Red | 1.52 | 1.48 | 1.46 | 1.44 | 1.46 | 1.48 | 1.43 |
| Yellow | 1.15 | 1.05 | 1.01 | 1.01 | 1.01 | 1.05 | 1.01 |
| Purple | 1.63 | 1.61 | 1.58 | 1.57 | 1.59 | 1.60 | 1.61 |
| Green | 1.62 | 1.34 | 1.33 | 1.30 | 1.34 | 1.38 | 1.34 |
| Cyan | 1.63 | 1.34 | 1.31 | 1.30 | 1.32 | 1.32 | 1.34 |
| SUM | 10.85 | 9.74 | 9.61 | 9.50 | 9.67 | 9.76 | 9.64 |
| HP-940c | | | | | | | |
| Black | 1.56 | 1.65 | 1.60 | 1.68 | 1.52 | 1.58 | 1.61 |
| Magenta | 1.68 | 1.66 | 1.64 | 1.61 | 1.65 | 1.64 | 1.63 |
| Red | 1.45 | 1.36 | 1.35 | 1.33 | 1.35 | 1.36 | 1.36 |
| Yellow | 1.24 | 1.17 | 1.16 | 1.16 | 1.17 | 1.17 | 1.17 |
| Purple | 1.79 | 1.77 | 1.74 | 1.72 | 1.75 | 1.74 | 1.74 |
| Green | 1.23 | 1.15 | 1.15 | 1.15 | 1.16 | 1.16 | 1.16 |
| Cyan | 1.54 | 1.46 | 1.46 | 1.46 | 1.48 | 1.48 | 1.49 |
| SUM | 10.49 | 10.25 | 10.10 | 10.11 | 10.08 | 10.13 | 10.16 |
| Epson Stylus 1270 | | | | | | | |
| Black | 1.76 | 1.87 | 1.84 | 1.82 | 1.84 | 1.84 | 1.82 |
| Magenta | 1.49 | 1.60 | 1.58 | 1.55 | 1.56 | 1.59 | 1.56 |
| Red | 1.42 | 1.51 | 1.49 | 1.49 | 1.49 | 1.51 | 1.47 |
| Yellow | 1.13 | 1.11 | 1.11 | 1.11 | 1.11 | 1.13 | 1.12 |
| Purple | 1.63 | 1.80 | 1.77 | 1.77 | 1.74 | 1.75 | 1.73 |
| Green | 1.43 | 1.66 | 1.62 | 1.61 | 1.58 | 1.58 | 1.55 |
| Cyan | 1.72 | 1.82 | 1.80 | 1.81 | 1.82 | 1.83 | 1.81 |
| SUM | 10.58 | 11.38 | 11.21 | 11.16 | 11.14 | 11.23 | 11.06 |

Examples 8 to 14 generally demonstrate that images recorded on the ink jet recording materials of the present invention will achieve high image densities regardless of whether they are imaged on wide or narrow format printers.

### Examples 15 to 21

In these examples, the ink jet recording materials of the present invention were imaged using HP 2500 CP and NOVAJET 630 wide format printers and HP-940c and EPSON 1270 narrow format printers, and the imaged materials evaluated for lightfastness, waterfastness, mottle, wicking, intercolor bleeding and humidity resistance. The results are set forth in Table 5, hereinbelow.

TABLE 5
Summary of Examples 15 to 21

| | Example | | | | | | |
|---|---|---|---|---|---|---|---|
| | 15 | 16 | 17 | 18 | 19 | 20 | 21 |
| Aqueous Coating | I | II | III | IV | V | VI | VII |
| Formulation | | | | | | | |
| BINDER/100 PARTS | 42.7 | 12.5 | 12.5 | 12.5 | 16.7 | 16.7 | 16.7 |
| PIGMENT¹ | | | | | | | |
| BINDER/PIGMENT | 1/2.3 | 1/8.0 | 1/8.0 | 1/8.0 | 1/6.0 | 1/6.0 | 1/6.0 |
| RATIO² | | | | | | | |
| Image Densities | | | | | | | |
| HP-2500 CP | | | | | | | |
| Lightfastness (%) | 95 | 95 | 95 | 95 | 95 | 95 | 95 |
| Waterfastness (%) | 100 | 99 | 99 | 100 | 98 | 98 | 99 |
| Waterfastness (V) | 1 | 1 | 1 | 1 | 1 | 1 | 1 |
| Mottle (P, F) | P | P | P | P | P | P | P |
| Wicking | 1 | 1 | 1 | 1 | 1 | 1 | 1 |
| Intercolor Bleeding | 3 | 1 | 1 | 1 | 1 | 1 | 1 |
| Humidity | 110 | 128 | 127 | 126 | 128 | 126 | 126 |
| Resistance (%) | | | | | | | |
| Δ (max % - 100) | 20 | 52 | 50 | 48 | 52 | 47 | 44 |
| NOVAJET 630 | | | | | | | |
| Lightfastness (%) | 86 | 87 | 87 | 87 | 87 | 87 | 87 |
| Waterfastness (%) | 98 | 101 | 104 | 103 | 102 | 102 | 102 |
| Waterfastness (V) | 3 | 3 | 3 | 3 | 3 | 3 | 3 |
| Mottle (P, F) | P | P | P | P | P | P | P |
| Wicking | 1 | 1 | 1 | 1 | 1 | 1 | 1 |
| Intercolor Bleeding | 1 | 1 | 1 | 1 | 1 | 1 | 1 |
| Humidity | 132 | 171 | 172 | 168 | 173 | 165 | 162 |
| Resistance (%) | | | | | | | |
| Δ (max % - 100) | 63 | 115 | 115 | 110 | 110 | 97 | 97 |
| HP-940c | | | | | | | |
| Lightfastness (%) | 94 | 93 | 94 | 93 | 93 | 93 | 93 |
| Waterfastness (%) | 95 | 99 | 99 | 99 | 99 | 99 | 99 |
| Waterfastness (V) | 2 | 2 | 2 | 2 | 2 | 2 | 2 |
| Mottle (P, F) | P | P | P | P | P | P | P |
| Wicking | 1 | 1 | 1 | 1 | 1 | 1 | 1 |
| Intercolor Bleeding | 1 | 1 | 1 | 1 | 1 | 1 | 1 |
| Humidity | 122 | 139 | 141 | 138 | 138 | 138 | 138 |
| Resistance (%) | | | | | | | |
| Δ (max % - 100) | 26 | 48 | 50 | 46 | 48 | 47 | 47 |
| Epson Stylus 1270 | | | | | | | |
| Lightfastness (%) | 95 | 95 | 95 | 95 | 96 | 95 | 95 |
| Waterfastness (%) | 103 | 100 | 101 | 101 | 102 | 100 | 102 |
| Waterfastness (V) | 3 | 3 | 3 | 3 | 3 | 3 | 3 |
| Mottle (P, F) | P | P | P | P | P | P | P |
| Wicking | 3 | 1 | 1 | 1 | 1 | 1 | 1 |
| Intercolor Bleeding | 3 | 1 | 1 | 1 | 1 | 1 | 1 |
| Humidity | 98 | 99 | 100 | 100 | 100 | 100 | 100 |
| Resistance (%) | | | | | | | |
| Δ (max % - 100) | 6 | 9 | 12 | 14 | 14 | 11 | 11 |

As shown in Table 5, the ink jet recording materials of the present invention demonstrate a good balance of properties regardless of whether they are imaged on wide or narrow format printers. In particular, Examples 15 to 21 exhibit good lightfastness and waterfastness, excellent wicking performance, low intercolor bleeding and good humidity resistance, while producing printed images having visual uniformity.

While the subject invention has been described in detail with reference to specific embodiments thereof, it will be apparent to those skilled in the art that various changes and modifications can be made therein without departing from the spirit and scope thereof.

We claim:

1. An aqueous coating formulation suitable for use with high-speed coaters such as rod and blade coaters, which comprises:
a pigment composition comprising greater than or equal to 50% by dry wt., based on the total dry weight of the pigment composition, of a first pigment selected from the group of porous organic pigments, porous inorganic pigments, metal oxide gels and mixtures thereof, and less than 50% by dry wt., based on the total dry weight of the pigment composition, of a second pigment selected from the group of calcium carbonate and mixtures of calcium carbonate and alumina; and
a binder,
wherein, the binder/pigment dry weight ratio in the coating formulation ranges from about 1:8 to about 1:1.

2. The aqueous coating formulation of claim 1, wherein the pigment composition comprises from about 65 to about 90% by dry wt., based on the total dry weight of the pigment composition, of the first pigment, and from about 35 to about 10% by dry wt., based on the total dry weight of the pigment composition, of the second pigment.

3. The aqueous coating formulation of claim 2, wherein the pigment composition comprises from about 80 to about 90% by dry wt., based on the total dry weight of the pigment composition, of the first pigment, and from about 20 to about 10% by dry wt., based on the total dry weight of the pigment composition, of the second pigment.

4. The aqueous coating formulation of claim 1, which has a Brookfield viscosity of from about 100 to about 1800 centipoise (at 21° C., 100 rpm, from about 15 to about 35% aqueous solution).

5. The aqueous coating formulation of claim 1, which has a high shear Hercules viscosity of from about 10 to about 50 centipoise at 8800 rpm, using an F2.5 bob.

6. The aqueous coating formulation of claim 1, which has a pH ranging from 6.5 to 8.

7. The aqueous coating formulation of claim 1, wherein the first pigment is a porous organic pigment selected from the group of acrylic resins, poly(vinylpolypyrriolidone), styrene resins, styrene-acrylic resins, urea-formaldehyde resins, polyvinyl chlorides, polycarbonates, and mixtures thereof.

8. The aqueous coating formulation of claim 1, wherein the first pigment is a porous inorganic pigment selected from the group of porous alumina, porous sodium aluminosilicate, porous calcium carbonate, porous clays, porous magnesium carbonate, porous synthetic amorphous silica and mixtures thereof.

9. The aqueous coating formulation of claim 1, wherein the first pigment is a metal oxide gel selected from the group of alumina gels, silica gels, polymeric gels, urea-formaldehyde gels, titania gels and mixtures thereof.

10. The aqueous coating formulation of claim 9, wherein the metal oxide gel is a silica gel having a surface area ranging from about 200 to about 800 square meters per gram, a pore volume ranging from about 0.4 to about 3.0 cubic centimeters per gram, an average particle size ranging from about 1 to about 17 microns and a pH ranging from about 2.5 to about 10.5.

11. The aqueous coating formulation of claim 1, wherein the second pigment is calcium carbonate.

12. The aqueous coating formulation of claim 11, wherein the calcium carbonate is a precipitated calcium carbonate having a surface area ranging from about 10 to about 300 square meters per gram and a particle size ranging from about 0.1 to about 5 microns.

13. The aqueous coating formulation of claim 1, wherein the second pigment is a mixture of calcium carbonate and alumina.

14. The aqueous coating formulation of claim 13, wherein the mixture comprises from about 60 to about 99% by dry wt. of calcium carbonate and from about 40 to about 1% by dry wt. of alumina.

15. The aqueous coating formulation of claim 14, wherein the calcium carbonate is a precipitated calcium carbonate having a surface area ranging from about 10 to about 300 square meters per gram and a particle size ranging from about 0.1 to about 5 microns, and wherein the alumina has an average particle diameter ranging from about 0.1 to about 3.0 microns.

16. The aqueous coating formulation of claim 1, wherein the binder is a water-soluble binder selected from the group of super, fully and partially hydrolyzed polyvinyl alcohols and mixtures thereof and, optionally, one or more cationic acrylic resins.

17. The aqueous coating formulation of claim 1, which is prepared by a process comprising adding the pigments and the binder to water in the following order of addition: the second pigment, the binder, the first pigment.

18. An aqueous coating formulation suitable for use with high-speed coaters such as rod and blade coaters, which comprises:
a pigment composition comprising greater than or equal to 50% by dry wt., based on the total dry weight of the pigment composition, of a silica gel, and less than 50% by dry wt., based on the total dry weight of the pigment composition, of a second pigment selected from the group of calcium carbonate and mixtures of calcium carbonate and alumina; and
a water-soluble binder selected from the group of super, fully and partially hydrolyzed polyvinyl alcohols and mixtures thereof and, optionally, one or more cationic acrylic resins,
wherein, the binder/pigment dry weight ratio in the coating formulation ranges from about 1:8 to about 1:1.

19. The aqueous coating formulation of claim 18, wherein the silica gel is present in an amount ranging from about 65 to about 90% by dry wt., based on the total dry weight of the pigment composition, and wherein the second pigment is present in an amount ranging from about 35 to about 10% by dry wt., based on the total dry weight of the pigment composition.

20. The aqueous coating formulation of claim 19, wherein the silica gel is present in an amount ranging from about 80 to about 90% by dry wt., based on the total dry weight of the pigment composition, and wherein the second pigment is present in an amount ranging from about 20 to about 10% by dry wt., based on the total dry weight of the pigment composition.

21. The aqueous coating formulation of claim 18, wherein the binder is a water-soluble binder selected from the group of super, fully and partially hydrolyzed polyvinyl alcohols and mixtures thereof and, optionally, one or more cationic acrylic resins.

22. The aqueous coating formulation of claim 18, which has a Brookfield viscosity of from about 100 to about 1800 centipoise (at 21° C., 100 rpm, from about 15 to about 35% aqueous solution).

23. The aqueous coating formulation of claim 18, which has a high shear Hercules viscosity of from about 10 to about 50 centipoise at 8800 rpm, using an F2.5 bob.

24. The aqueous coating formulation of claim 18, which has a pH ranging from 6.5 to 8.

25. The aqueous coating formulation of claim 18, which is prepared by a process comprising adding the pigments and the binder to water in the following order of addition: the second pigment, the binder, the silica gel.

26. An aqueous coating formulation suitable for use with high-speed coaters such as rod and blade coaters, which comprises:
a pigment composition comprising from about 65 to about 90% by dry wt., based on the total dry weight of the pigment composition, of a silica gel, and from about 35 to about 10% by dry wt., based on the total dry weight of the pigment composition, of a precipitated calcium carbonate pigment having a surface area ranging from about 30 to about 200 square meters per gram and a particle size ranging from about 0.1 to about 5 microns; and
a water-soluble binder selected from the group of super, fully and partially hydrolyzed polyvinyl alcohols and mixtures thereof and, optionally, one or more cationic acrylic resins,
wherein, the binder/pigment dry weight ratio in the coating formulation ranges from about 1:6 to about 1:1.5.

27. The aqueous coating formulation of claim 26, which has a Brookfield viscosity of from about 100 to about 1800 centipoise (at 21° C., 100 rpm, from about 15 to about 35% aqueous solution).

28. The aqueous coating formulation of claim 26, which has a high shear Hercules viscosity of from about 10 to about 50 centipoise at 8800 rpm, using an F2.5 bob.

29. The aqueous coating formulation of claim 26, which has a pH ranging from 6.5 to 8.

30. An ink jet recording material, which comprises:
(i) a substrate; and
(ii) one or more ink jet receptive layers located on the substrate, which are prepared using an aqueous coating formulation comprising:
(a) a pigment composition comprising greater than or equal to 50% by dry wt., based on the total dry weight of the pigment composition, of a first pigment selected from the group of porous organic pigments, porous inorganic pigments, metal oxide gels and mixtures thereof, and less than 50% by dry wt., based on the total dry weight of the pigment composition, of a second pigment selected from the group of calcium carbonate and mixtures of calcium carbonate and alumina; and
(b) a binder,
wherein, the binder/pigment dry weight ratio in the coating formulation ranges from about 1:8 to about 1:1.

31. An ink jet recording material, which comprises:
(i) a substrate; and
(ii) one or more ink jet receptive layers located on the substrate, which are prepared using an aqueous coating formulation comprising:
(a) a pigment composition comprising from about 65 to about 90% by dry wt., based on the total dry weight of the pigment composition, of a silica gel, and from about 35 to about 10% by dry wt., based on the total dry weight of the pigment composition, of a precipitated calcium carbonate pigment having a surface area ranging from about 30 to about 200 square meters per gram and a particle size ranging from about 0.1 to about 5 microns; and
(b) a water-soluble binder selected from the group of super, fully and partially hydrolyzed polyvinyl alcohols and mixtures thereof and, optionally, one or more cationic acrylic resins,
wherein, the binder/pigment dry weight ratio in the coating formulation ranges from about 1:6 to about 1:1.5.
